(19) United States
(12) Patent Application Publication
(10) Pub. No.: US 2004/0015421 A1
(43) Pub. Date: Jan. 22, 2004

(54) Method for recording charges in a communications network

(76) Inventors: Frank Erfurt, Kleinmachnow (DE); Eckhard Mauersberger, Berlin (DE); Annett Seefeldt, Berlin (DE)

Correspondence Address: MORRISON & FOERSTER LLP, 1650 TYSONS BOULEVARD, SUITE 300, MCLEAN, VA, 22102, US

(21) Appl. No.: 10/221,025

(22) PCT Filed: Mar. 13, 2001
(86) PCT No.: PCT/EP01/02800

(30) Foreign Application Priority Data
Mar. 14, 2000 (EP) 00105245.5

(51) Int. Cl. G06F 17/60

(52) U.S. Cl. 705/32

(57) ABSTRACT

The invention relates to a method for recording charges in a communications network with a network node (account node 4) for managing at least one account of a communications subscriber (1) conducted as a credit account and with a network node (recording node 3) for recording the accrued charges. According to the invention, a portion of the account balance is specified as a charge limit. The recording node (3) compares the amount of the charges accrued during the communications connection with the charge limit, and an attainment message (ACR) is sent to the account node when the charges reach the charge limit. In order to also be able to record charges of considerably different amounts, exceed data is generated when the charges are based on an individual request that exceeds the amount of the charge limit, and an increased charge limit is established based on this exceed data.

The invention relates to a method for recording costs in a communications network having a network node (account node) for managing at least one account, run as a credit account, belonging to a communications subscriber and having a network node (recording node) for recording the costs incurred, in which, when a communications link is set up by the communications subscriber, the account node uses a limit message to prescribe to the recording node a portion of the account balance in the account as a cost limit, the recording node compares the level of the costs incurred during the communications link with the cost limit, and the recording node sends an attainment message to the account node when the costs have reached the cost limit.

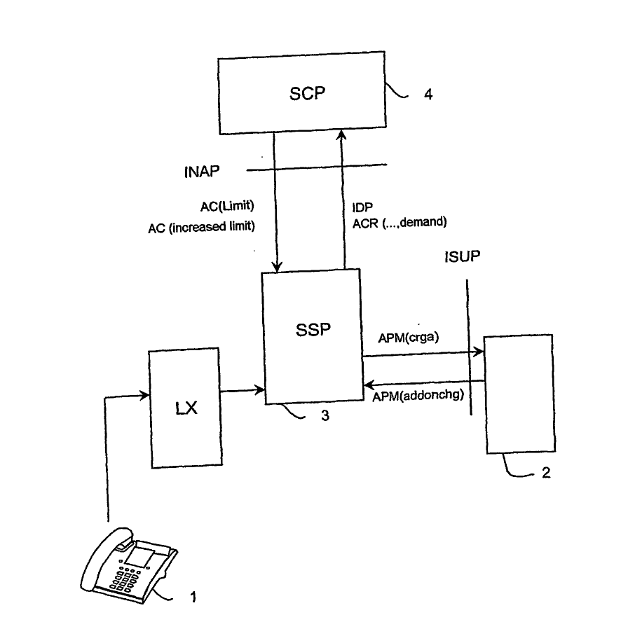

Such a method can be found in the publication “DEN/SPAN-03063-1.2 V0.1.0 (Mar. 3, 2000), Intelligent Network (IN); Intelligent Network Application Protocol (INAP); Capability Set 3 (CS3); Part 1.2: Protocol specification, SCF-SSF Interface, Subpart F, Version: Feb. 28th, 2000” from the organization ETSI, particularly in FIG. 10 on page 107. In this context, a node SCP is used as an account node, and a node SSP is used as a recording node. When the communications link is set up, the node SCP uses a message AC, which serves as a limit message, to send a cost limit to the node SSP. The recording node (the node SSP) is notified of the costs incurred in the form of cost messages (denoted by “crgt” in FIG. 10 of the publication); these costs incurred are summed by the node SSP if appropriate. The node SSP compares the level of the costs incurred with the cost limit and, when the cost limit is reached, returns a message ACR to the node SCP as an attainment message.

The invention is based on the object of further developing the method cited above such that costs which are incurred during the communications link and have very different levels can be recorded. The invention achieves this object for a method of the type cited in the introduction by virtue of exceed data being formed if the costs are based on an individual demand which exceeds the level of the cost limit; the exceed data being transmitted with the attainment message, and the account node taking these exceed data as a basis for ascertaining a cost limit which is higher than the cost limit and notifying the recording node thereof using a further limit message. The inventive method can be used in communications networks which can be used to transmit, by way of example, voice or data or voice and data. Examples of such networks are the telephone network, the Internet or a telephone network which is connected to the Internet.

A particular advantage of the inventive method is that very high costs incurred, for example individual demands which actually exceed the cost limit on their own, can also be recorded. In this context, an individual demand is to be understood to mean a message to the recording node which instructs said recording node to record an accurately defined cost sum and to compare it independently with the cost limit. Individual demands within the context of the invention can indeed also occur a plurality of times in succession or periodically but are always handled independently, and also independently result in the formation of the overwriting data if they independently exceed the level of the cost limit in each case.

One particular embodiment of the inventive method provides for the occurrence of the exceed data to set the level of the increased cost limit to twice the level of the cost limit. This embodiment allows the account node to ascertain the level of the increased cost limit in a particularly simple manner. If the increased cost limit ascertained in this manner is again not sufficient for handling the individual demand, then the account node can be notified of this information with further exceed data and then doubles the level of the cost limit again. In this manner, an increased cost limit of sufficient level is achieved after possibly more than one doubling.

The inventive method can also advantageously be designed such that the level of the individual demand is transmitted with the exceed data, and the account node stipulates the increased cost limit such that it is at least as high as the individual demand. A particular advantage in this context is that the account node is informed of the level of the individual demand by the exceed data, which means that it can immediately stipulate an increased cost limit of sufficient size. In this context, the situation does not arise in which the account node needs to increase the cost limit a plurality of times until the individual demand can be handled. This embodiment of the inventive method is therefore particularly fast.

Advantageously, the inventive method can be designed such that the exceed data are transmitted as part of a parameter in the “ApplyChargingReport” message of the “Intelligent Network Application Protocol” transmission protocol.

Since, as can be gleaned from the publication mentioned in the introduction, the “ApplyChargingReport” message can be used in order to send it as an attainment message from the recording node to the account node, it is appropriate to use an inventively changed parameter in the “ApplyChargingReport” message to transmit the exceed data to the account node.

To explain the inventive method further, reference is made to part of a communications network which is shown schematically in the figure.

The communications network shown provides a communications subscriber 1 with the opportunity to use a service provided by a service provider 2. In this case, the service provider 2 can be part of the same communications network as the communications subscriber 1, or else it can be in a different communications network which is connected to the communications network used by the communications subscriber 1. The communications network used by the communications subscriber 1 contains, as parts which are fundamental to the inventive method, an exchange LX, a service switching point SSP and a service control point SCP. This communications network thus has the structure of an intelligent network (IN). Such intelligent networks, as such, are described, by way of example, in the book “Technik der Netze” [Network Technology] by Gerd Siegmund, 4th revised and expanded edition, published in 1999 by Hüthig Verlag, Heidelberg, particularly in section 6.4 “Intelligent Networks”. For communication between the service switching point SSP and the service control point SCP, an INAP (Intelligent Network Application Protocol) communications protocol is used. For communication between the service switching point SSP and the service provider 2, an ISUP (ISDN User Part) communications protocol is used. The INAP communications protocol is described, by way of example, in ETSI standard EN 301 140-1, and the ISUP communications protocol is described in ETSI standard ES 201 296.

To use a service provided by the service provider 2, the communications subscriber 1 dials a telephone number for the service provider 2. This sets up a connection to the exchange LX, which sets up the connection further to the service switching point SSP.

In the implementation of the inventive method, the service switching point SSP has the function of the recording node and is therefore uniformly referred to below as “recording node 3”. From the type of connection, the recording node 3 identifies that the communications subscriber 1 is paying for his communications link using a credit account, and it sends a message IDM (Initial Detection Point) to the service control point SCP. In the implementation of the inventive method, the service control point SCP has the function of the account node and is therefore uniformly referred to below as “account node 4”. The account node 4 then reads the level of the credit account (e.g. an account for “prepaid card service”) belonging to the communications subscriber 1 and sends a portion of the account balance as a cost limit to the recording node 3 using the message AC(Limit). In this case, the level of the cost limit is DM 10.00, for example. The level of this first cost limit is stored in the account node 4 individually for each communications subscriber, or there is a level which is initially valid for all the communications subscribers at the same time. On the basis of this initially adequate cost limit, the recording node 3 can now set up the connection to the service provider 2. If the communications subscriber 1 now uses a service provided by the service provider 2, then this service can sometimes incur substantial costs. This can be the case, by way of example, if the service provider 2 provides information for whose use it charges on a time-dependent or flat-rate basis (“Premium Rate Services”; Content charging). As another example, the service provider 2 can engage in electronic commerce (E-commerce) and can offer goods or services for the communications subscriber 1 to purchase, for example.

For the costs incurred for the purchase, the service provider 2 now sends an individual demand in the form of a message APM (addonchg) to the recording node 3. The abbreviation “addonchg” stands for “Add-on-Charge” and denotes additionally incurred costs, in this case for purchasing in electronic commerce, for example. APM (Application Transport Mechanism) is a mechanism for transmitting data; an APM message can be regarded as a container in which the individual demand for the costs is transported to the recording node 3. The mechanism APM is defined in the ISUP communications protocol.

In this case, the level of the individual demand is DM 100.00, for example. The recording node 3 now compares the level of the individual demand, which in this case represents the costs, with the level of the cost limit known to it (DM 10.00) and establishes that the individual demand is higher than the cost limit. The recording node 3 then forms exceed data containing the information “level of the current cost limit is too low for an individual demand amounting to DM 100.00”. The recording node 3 uses a message ACR( . . . , demand), serving as attainment message, to send these exceed data to the account node 4. The “demand” parameter in the attainment message ACR contains the exceed data in this case. The account node 4 then uses the exceed data to determine the level of the increased limit such that said increased limit is higher than the individual demand; by way of example, it sets the increased limit to DM 110.00 and uses a further message AC(increased limit) to send it to the recording node 3. The recording accounts 3 now has a limit available which is higher than the individual demand of DM 100.00; this limit can thus be used to handle the individual demand from the service provider 2. To signal this, the recording node 3 sends an acknowledgement message APM(crga) (crga=Charging Acknowledgement Information) to the service provider 2.

At this juncture, it will be pointed out that the credit account managed in DM in this exemplary embodiment and also the cost limits, which are therefore likewise in DM, and the individual demand which is in DM are to be understood merely by way of example. The credit account, the cost limits and the individual demands can, by way of example, also be managed or arise in any other currency or else in cost units (for example units of DM 0.12 each). Similarly, the SSP used as the recording node in the exemplary embodiment is merely to be understood as an example; it is likewise possible to use, by way of example, a GPRS node (GPRS=General Packet Radio Service), an H.323 gatekeeper/media gateway controller or an SIP proxy as the recording node.

1. A method for recording costs in a communications network having a
network node (account node 4) for managing at least one account, run as a credit account, belonging to a communications subscriber (1), and having a
a network node (recording node 3) for recording the costs incurred, in which,
when a communications link is set up by the communications subscriber (1), the account node (4) uses a limit message (AC(Limit)) to prescribe to the recording node (3) a portion of the account balance in the account as a cost limit,
the recording node (3) compares the level of the costs incurred during the communications link with the cost limit, and
the recording node (3) sends an attainment message (ACR) to the account node when the costs have reached the cost limit, characterized in that
exceed data are formed if the costs are based on an individual demand which exceeds the level of the cost limit,
the exceed data are transmitted with the attainment message (ACR), and
the account node (4) takes these exceed data as a basis for ascertaining a cost limit which is higher than the cost limit and notifies the recording node (3) thereof using a further limit message (AC (increased limit)).

2. The method as claimed in claim 1, characterized in that
the occurrence of the exceed data sets the level of the increased cost limit to twice the level of the cost limit.

3. The method as claimed in claim 1, characterized in that
the level of the individual demand is transmitted with the exceed data, and
the account node stipulates the increased cost limit such that it is at least as high as the individual demand.

4. The method as claimed in one of claims 1 to 3, characterized in that
the exceed data are transmitted as part of a parameter in the “ApplyChargingReport” message of the “Intelligent Network Application Protocol” transmission protocol.
